(19) United States
(12) Patent Application Publication
(10) Pub. No.: US 2013/0170030 A1
(43) Pub. Date: Jul. 4, 2013

(54) STEREOSCOPIC DISPLAY APPARATUS

(71) Applicant: June-Jei HUANG, TAOYUAN HSIEN (TW)

(72) Inventor: June-Jei HUANG, TAOYUAN HSIEN (TW)

(73) Assignee: DELTA ELECTRONICS, INC., TAOYUAN HSIEN (TW)

(21) Appl. No.: 13/527,556

(22) Filed: Jun. 19, 2012

(30) Foreign Application Priority Data
Dec. 29, 2011 (TW) 100149421

(51) Int. Cl. G02B 27/26

(52) U.S. Cl. 359/465

(57) ABSTRACT

A stereoscopic display apparatus includes a projection lens, a light source, a first and a second polarized beam splitters, a first and a second optical guiding system. The light source can radiate non-polarized light. The first polarized beam splitter divides the non-polarized light into P-polarized light and S-polarized light. The first optical guiding system guides the P-polarized light to the second polarized beam splitter, and the second optical guiding system guides the S-polarized light to the second polarized beam splitter. The second polarized beam splitter combines and transmits the P-polarized light and S-polarized light to the projection lens.

### RELATED APPLICATIONS

This application claims priority to Taiwan Application Serial Number 100149421, filed Dec. 29, 2011, which is herein incorporated by reference.

### BACKGROUND

1. Technical Field

The present disclosure relates to display devices, and more particularly, stereoscopic display apparatus.

2. Description of Related Art

Providing vivid images to the consumers has long been the goal of display manufacturers and researchers. Among various advanced techniques, the application of three-dimensional (3D) stereoscopy is one of the most sought after fields.

From the technical aspect, 3D imaging is achieved by using the parallax due to the different views from the eyes of a viewer. Generally, 3D stereoscopic techniques may be categorized into glasses-aided stereoscopy and glass-free, naked-eye stereoscopy. For 3D stereoscopy that requires glasses, there are two types of glasses commonly used to view 3D images; that is, active shutter glasses and passive polarized glasses. The disadvantage of active shutter glasses is that they are heavy and expensive, and require battery replacement. The shortcoming of passive polarized glasses is that they require a display apparatus providing two different polarizations to present the left and right images.

FIG. 1 illustrates a 3D image projection display apparatus according to U.S. Pat. No. 7,690,794, which comprises a polarization beam splitter and two light modulators. However, this apparatus has the following disadvantages:

1. The polarization beam splitter (PBS) 10 is used for both separating and combining S and P polarizations for two spatial light modulators. For example, each light modulator may be a digital micro-mirror device (DMD) 30a or 30b , the incident light path is different to its reflected exit light path. The two light paths have two different incident angles. A special polarization beam splitter must be made to meet the requirements of two different incident angles because the splitting of polarizations is very angle sensitive;

2. A quarter wave plates 31a and 31b must be used on top of the spatial light modulator. When light comes and goes from the spatial light modulator, it passes this quarter wave plate twice and changes its polarization state. Again, the quarter wave plate is very angle sensitive. Light loss is unavoidable especially when come and go with two different incident angles;

3. As shown in FIG. 2, the incident light 21 for DMD must come from its one diagonal direction. As shown in FIGS. 3 and 4, if two DMD 30a , 30b are disposed on two sides of the PBS cube 10, either two incident light paths from two different diagonal directions, or two kinds of DMD panels with pivots at two diagonal directions, must be used. If these two choices cannot be made, another extra fold must be added in one of the light paths of the DMD panels, as shown in FIG. 1. The Bigger PBS cube and longer back focal length for the projection lens 50 are the drawbacks it will introduce.

In view of the foregoing, there exist problems and disadvantages in the current 3D stereoscopic display techniques that await further improvement. However, those skilled in the art sought vainly for a solution. In order to solve or circumvent above problems and disadvantages, there is an urgent need in the related field to provide three-dimensional imaging conveniently.

### SUMMARY

The following presents a simplified summary of the disclosure in order to provide a basic understanding to the reader. This summary is not an extensive overview of the disclosure and it does not identify key/critical elements of the present invention or delineate the scope of the present invention. Its sole purpose is to present some concepts disclosed herein in a simplified form as a prelude to the more detailed description that is presented later.

According to one embodiment of the present invention, a stereoscopic display apparatus includes a projection lens, a light source, a first and a second polarized beam splitters, a first and a second optical guiding system. The light source can radiate non-polarized light. The first polarized beam splitter divides the non-polarized light into P-polarized light and S-polarized light. The first optical guiding system guides the P-polarized light to the second polarized beam splitter, and the second optical guiding system guides the S-polarized light to the second polarized beam splitter. The second polarized beam splitter combines and transmits the P-polarized light and S-polarized light to the Projection lens.

The first optical guiding system includes a first spatial light modulator and a first total internal reflection prism. The first total internal reflection prism reflects the P-polarized light to the first spatial light modulator, and then the first spatial light modulator reflects the P-polarized light back to the first total internal reflection prism, so that the P-polarized light can be transmitted through the first total internal reflection prism to the second polarized beam splitter.

The first optical guiding system also includes a first lens, a second lens, a third lens, a first reflective mirror and a second reflective mirror. From the first polarized beam splitter to the first total internal reflection prism, in sequential order as the P-polarized light passes therethrough: the first lens, the first reflective mirror, the second lens, the second reflective mirror and the third lens.

The second optical guiding system includes a second spatial light modulator and a second total internal reflection prism. The second total internal reflection prism reflects the S-polarized light to the second spatial light modulator, and then the second spatial light modulator reflects the S-polarized light back to the first total internal reflection prism, so that the S-polarized light can be transmitted through the second total internal reflection prism to the second polarized beam splitter.

The second optical guiding system also includes a fourth lens, a fifth lens, a sixth lens, a third reflective mirror and a fourth reflective mirror. From the first polarized beam splitter to the second total internal reflection prism, in sequential order as the S-polarized light passes therethrough: the fourth lens, the third reflective mirror, the fifth lens, the fourth reflective mirror and the sixth lens.

The first spatial light modulator is a first digital micro-mirror device, and the second spatial light modulator is a second digital micro-mirror device.

An interval between the first spatial light modulator and the projection lens is longer than a thickness of the first polarized beam splitter plus a thickness of the second total internal reflection prism; an interval between the second spatial light modulator and the projection lens is longer than a thickness of the second polarized beam splitter plus the thickness of second total internal reflection prism.

An interval between the first spatial light modulator and the projection lens minus 10 mm is shorter than a thickness of the second polarized beam splitter plus a thickness of the first total internal reflection prism; an interval between the second spatial light modulator and the projection lens minus 10 mm is shorter than the thickness of the second polarized beam splitter plus a thickness of the second total internal reflection prism.

The stereoscopic display apparatus also includes an integration rod. The integration rod is coupled with the light source so that the non-polarized light transmitted through the integration rod to the first polarized beam splitter.

Technical advantages are generally achieved, by embodiments of the present invention, as follows:

1. Two polarization beam splitters are used, in which one for separating and the other for combining S and P polarizations. The incident and reflected light paths to the DMD traverse with two different angles but these two light paths are guided to two different PBS cubes designed for these two light paths. A normal polarization beam splitter can be used;

2. No quarter wave plate is required on the top of the spatial light modulator, and therefore light loss is reduced; and

3. Two DMD panels are not directly attached to PBS cube. Normal PBS cube and shorter back focal length for projection lens can be obtained.

Many of the attendant features will be more readily appreciated, as the same becomes better understood by reference to the following detailed description considered in connection with the accompanying drawings.

### BRIEF DESCRIPTION OF THE DRAWINGS

The present description will be better understood from the following detailed description read in light of the accompanying drawing, wherein:

FIG. 1 is a schematic drawing of a conventional stereoscopic projector;

FIG. 2 is a schematic drawing of digital micro-mirror devices of FIG. 1;

FIGS. 3-4 show two optical paths of the digital micro-mirror device with a polarization beam splitter;

FIG. 5 is a schematic drawing of a stereoscopic display apparatus according to one embodiment of the present disclosure;

FIG. 6 is a schematic drawing of an optical guiding system according to one embodiment of the present disclosure; and

FIGS. 7-9 are pictorial drawings of the stereoscopic display apparatus from various view angles according to one embodiment of the present disclosure.

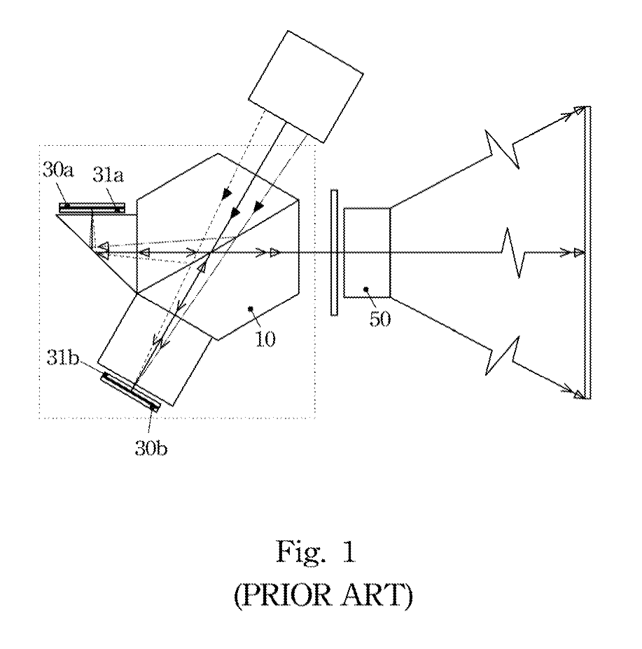

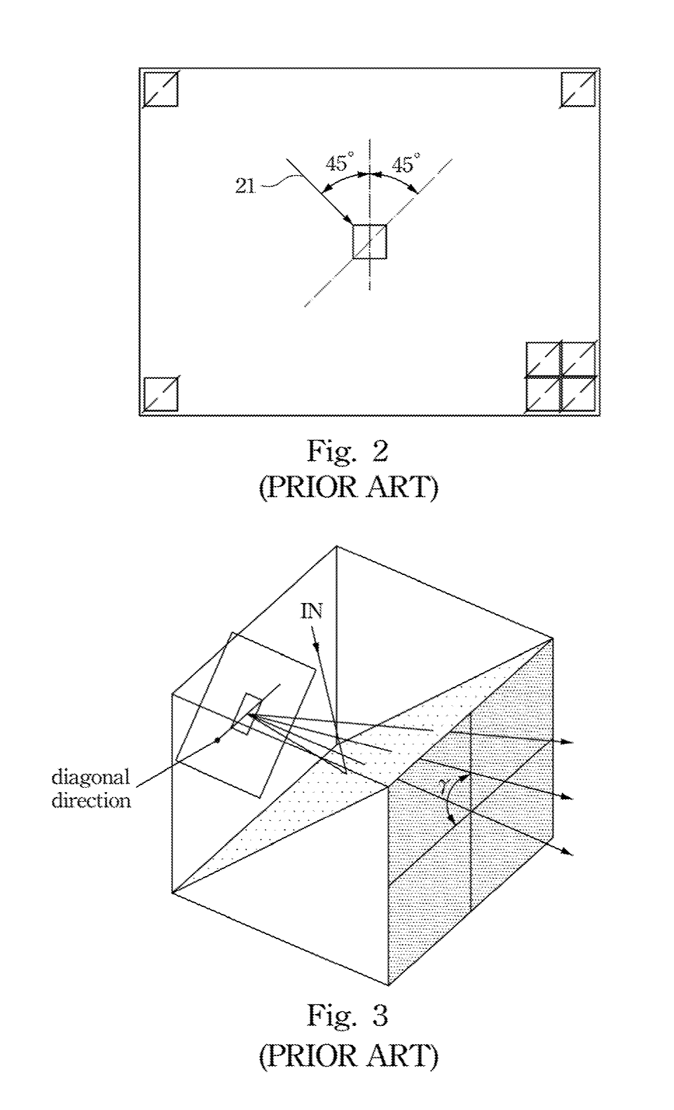

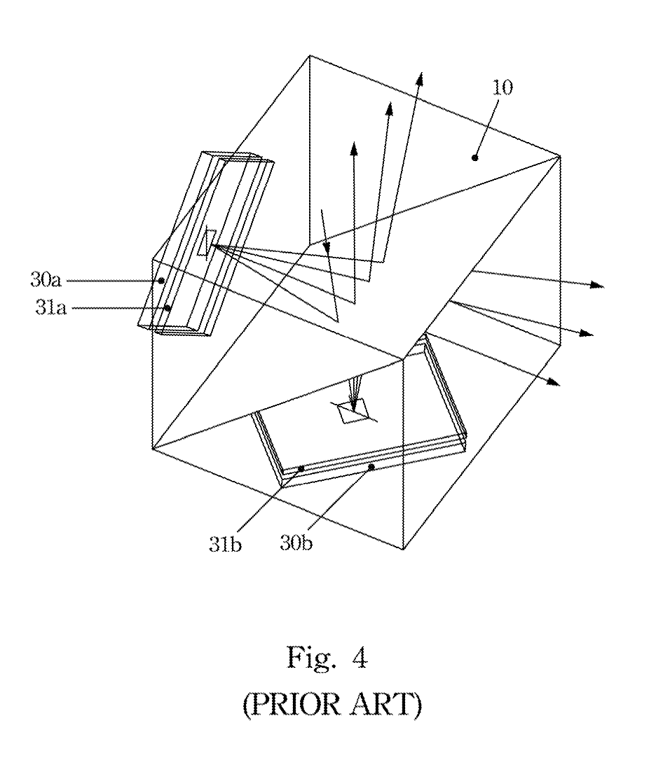

### DETAILED DESCRIPTION

In the following detailed description, for purposes of explanation, numerous specific details are set forth in order to attain a thorough understanding of the disclosed embodiments. It will be apparent, however, that one or more embodiments may be practiced without these specific details. In other instances, well-known structures and devices are schematically shown in order to simplify the drawing.

As used in the description herein and throughout the claims that follow, the meaning of “a”, “an”, and “the” includes reference to the plural unless the context clearly dictates otherwise. Also, as used in the description herein and throughout the claims that follow, the terms “comprise or comprising”, “include or including”, “have or having”, “contain or containing” and the like are to be understood to be open-ended, i.e., to mean including but not limited to. As used in the description herein and throughout the claims that follow, the meaning of “in” includes “in” and “on” unless the context clearly dictates otherwise.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

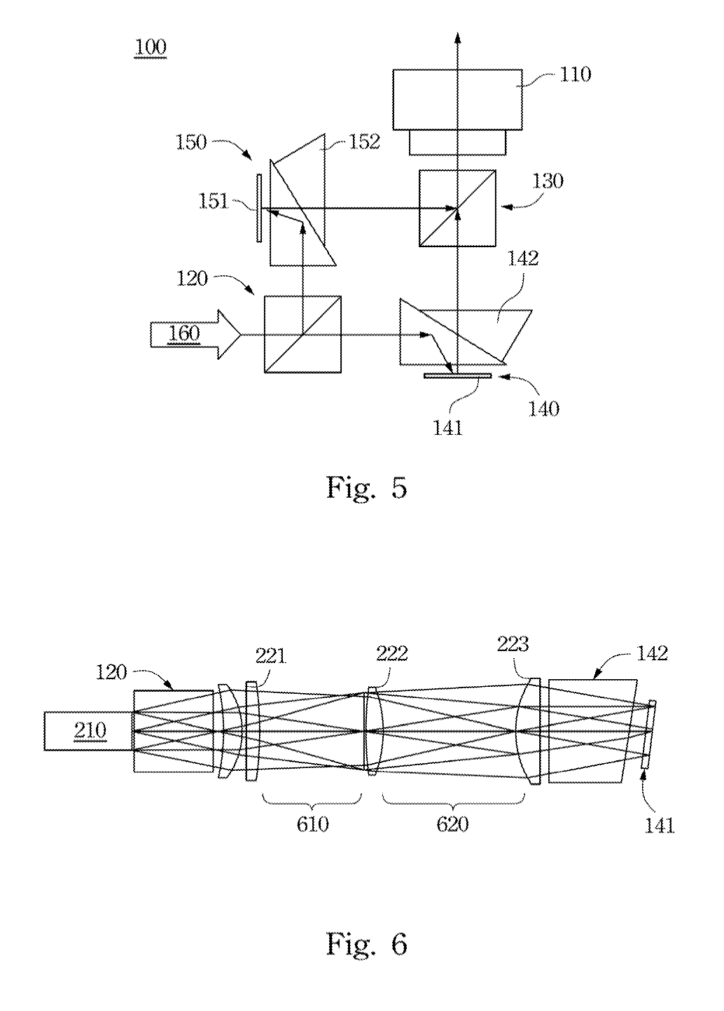

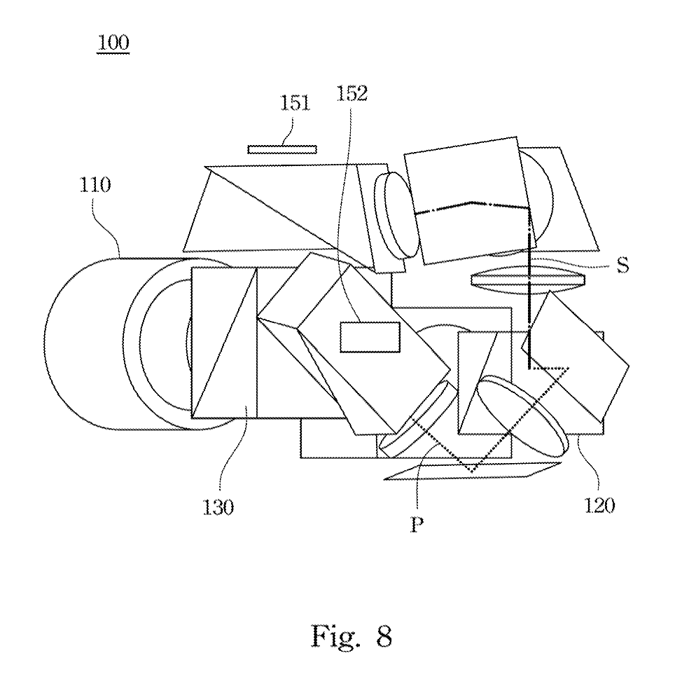

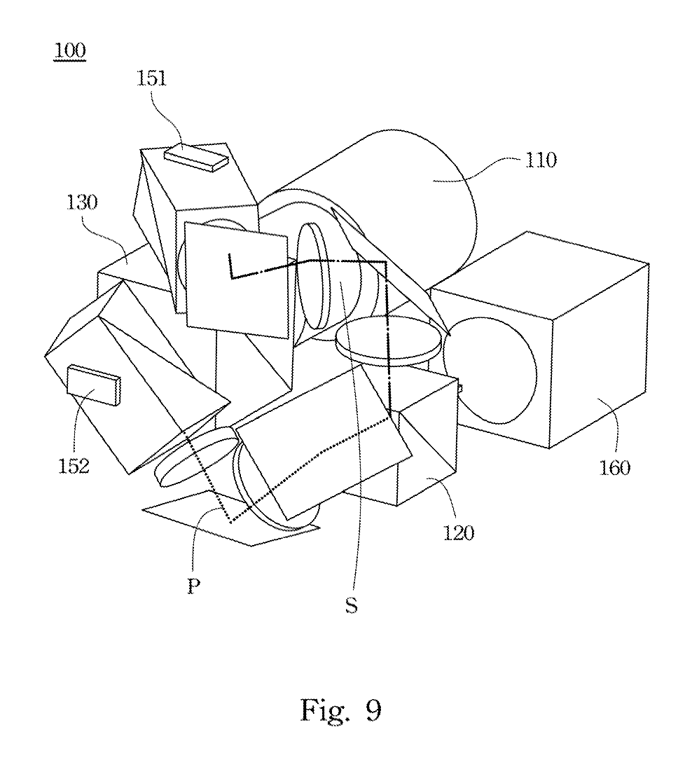

In one or more various aspects, the present invention is directed to a stereoscopic display apparatus. This apparatus may be easily inserted into a display, and may be applicable or readily adaptable to all related technology. For a more complete understanding of the stereoscopic display apparatus, and the advantages thereof, please refer to FIGS. 5-9 and embodiments of the present disclosure.

FIG. 5 is a schematic drawing of stereoscopic display apparatus 100 according to one embodiment of the present disclosure. As shown in FIG. 5, the stereoscopic display apparatus 100 includes a projection lens 110, a light source 160, a first polarized beam splitter 120, a second polarized beam splitter 130, a first second optical guiding system 140 and a second optical guiding system 150. The light source 160 can radiate non-polarized light. The first polarized beam splitter 120 divides the non-polarized light into P-polarized light and S-polarized light. The first optical guiding system 140 guides the P-polarized light to the second polarized beam splitter, and the second optical guiding system 150 guides the S-polarized light to the second polarized beam splitter. The second polarized beam splitter 130 combines and transmits the P-polarized light and S-polarized light to the projection lens 110, and then images can be projected to a screen, so that a viewer wearing polarizing glasses receives correct 2D images in each eye and thus perceives a stereoscopic 3D image.

Specifically, the first optical guiding system 140 includes a first spatial light modulator 141 and a first total internal reflection prism 142. The first total internal reflection prism 142 reflects the P-polarized light to the first spatial light modulator 141, and then the first spatial light modulator 141 reflects the P-polarized light back to the first total internal reflection prism 142, so that the P-polarized light can be transmitted through the first total internal reflection prism 142 to the second polarized beam splitter 130.

Similarly, the second optical guiding system 150 includes a second spatial light modulator 151 and a second total internal reflection prism 152. The second total internal reflection prism 152 reflects the S-polarized light to the second spatial light modulator 151, and then the second spatial light modulator 151 reflects the S-polarized light back to the second total internal reflection prism 152, so that the S-polarized light can be transmitted through the second total internal reflection prism 152 to the second polarized beam splitter 130.

For example, the first spatial light modulator 141 may be a first digital micro-mirror device, and the second spatial light modulator 151 may be a second digital micro-mirror device. When turned on, the digital micro-mirror device reflects light to the total internal reflection prism, so that the light can be transmitted through the total internal reflection prism. On the contrary, when turned off, the digital micro-mirror device guides the light to another place.

FIG. 6 is a schematic drawing of an optical guiding system according to one embodiment of the present disclosure. It should be noted that FIG. 6 shows an optical path of the P-polarized light that passes through the first optical guiding system 140. An optical path of the S-polarized light that passes through the second optical guiding system 150 is the same as the optical path of the P-polarized light and, thus, is not repeated herein.

As shown in FIG. 6, the first optical guiding system includes a first lens 221, a second lens 222 and a third lens 223. The P-polarized light is transmitted form the first polarized beam splitter 120 to the second lens 222 through the first lens 221 and a sequential optical path 610, and then the P-polarized light is transmitted form the second lens 222 to the first total internal reflection prism 142 through a optical path 620 and the sequential third lens 223.

The integration rod 210 is coupled with the light source 160 so that the non-polarized light transmitted through the integration rod 210 to the first polarized beam splitter 120, so as to uniform light.

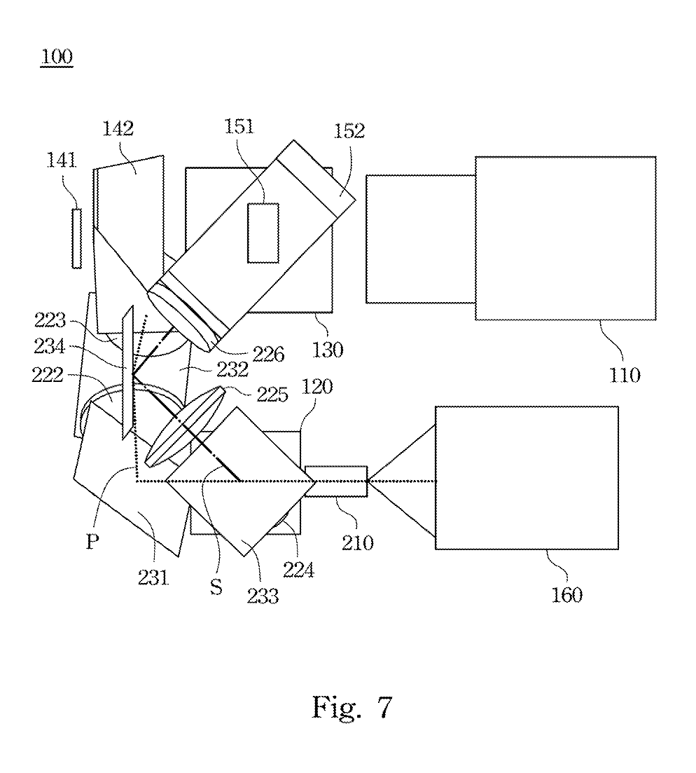

FIGS. 7-9 are pictorial drawings of the stereoscopic display apparatus 100 from various view angles according to one embodiment of the present disclosure. The first optical guiding system includes a first lens 221, a first reflective mirror 231, a second lens 222, a second reflective mirror 232 and a third lens 223. From the first polarized beam splitter 120 to the first total internal reflection prism 142, in sequential order as the P-polarized light passes therethrough: the first lens 221, the first reflective mirror 231, the second lens 222, the second reflective mirror 232 and the third lens 223. The light reflected by the first reflective mirror 231 corresponds to the optical path 610 in FIG. 6 schematically; the light reflected by the second reflective mirror 232 corresponds to the optical path 620 in FIG. 6 schematically.

Above second optical guiding system also includes a fourth lens 224, a fifth lens 225, a sixth lens 226, a third reflective mirror 233 and a fourth reflective mirror 234. From the first polarized beam splitter 120 to the second total internal reflection prism 152, in sequential order as the S-polarized light passes therethrough: the fourth lens 224, the third reflective mirror 233, the fifth lens 225, the fourth reflective mirror 234 and the sixth lens 226.

Compared with the prior art, the present invention provides two polarization beam splitters 120 and 130, in which one for separating and the other for combining S and P polarizations, without using the bigger PBS cube, and thereby reducing back focal length. Moreover, no quarter wave plate is needed, and therefore light loss is reduced.

Furthermore, an interval between the first spatial light modulator 141 and the projection lens 110 is longer than a thickness of the first polarized beam splitter 120 plus a thickness of the second total internal reflection prism 152. An interval between the second spatial light modulator 151 and the projection lens 110 is longer than a thickness of the second polarized beam splitter 130 plus the thickness of second total internal reflection prism 152.

In practice, an interval between the first spatial light modulator 141 and the projection lens 110 minus 10 mm is shorter than a thickness of the second polarized beam splitter 130 plus a thickness of the first total internal reflection prism 142; an interval between the second spatial light modulator 151 and the projection lens 110 minus 10 mm is shorter than the thickness of the second polarized beam splitter 130 plus a thickness of the second total internal reflection prism 152.

The reader's attention is directed to all papers and documents which are filed concurrently with his specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, 6th paragraph. In particular, the use of “step of” in the claims herein is not intended to invoke the provisions of 35 U.S.C. §112, 6th paragraph.

What is claimed is:

1. A stereoscopic display apparatus comprising:
a projection lens;
a light source for radiating non-polarized light;
a first polarized beam splitter for dividing the non-polarized light into P-polarized light and S-polarized light;
a second polarized beam splitter;
a first optical guiding system for guiding the P-polarized light to the second polarized beam splitter; and
a second optical guiding system for guiding the S-polarized light to the second polarized beam splitter, so that the second polarized beam splitter combines and transmits the P-polarized light and S-polarized light to the projection lens.

2. The stereoscopic display apparatus of claim 1, wherein the first optical guiding system comprises:
a first spatial light modulator; and
a first total internal reflection prism for reflecting the P-polarized light to the first spatial light modulator, and the first spatial light modulator for reflecting the P-polarized light back to the first total internal reflection prism, so that the P-polarized light is transmitted through the first total internal reflection prism to the second polarized beam splitter.

3. The stereoscopic display apparatus of claim 2, wherein the first optical guiding system further comprises:
a first lens, a second lens, a third lens, a first reflective mirror and a second reflective mirror, wherein from the first polarized beam splitter to the first total internal reflection prism, in sequential order as the P-polarized light passes therethrough: the first lens, the first reflective mirror, the second lens, the second reflective mirror and the third lens.

4. The stereoscopic display apparatus of claim 3, wherein the second optical guiding system comprises:
a second spatial light modulator; and
a second total internal reflection prism for reflecting the S-polarized light to the second spatial light modulator, and the second spatial light modulator for reflecting the S-polarized light back to the first total internal reflection prism, so that the S-polarized light is transmitted through the second total internal reflection prism to the second polarized beam splitter.

5. The stereoscopic display apparatus of claim 4, wherein the second optical guiding system further comprises:
a fourth lens, a fifth lens, a sixth lens, a third reflective mirror and a fourth reflective mirror, wherein from the first polarized beam splitter to the second total internal reflection prism, in sequential order as the S-polarized light passes therethrough: the fourth lens, the third reflective mirror, the fifth lens, the fourth reflective mirror and the sixth lens.

6. The stereoscopic display apparatus of claim 4, wherein the first spatial light modulator is a first digital micro-mirror device, and the second spatial light modulator is a second digital micro-mirror device.

7. The stereoscopic display apparatus of claim 4, wherein an interval between the first spatial light modulator and the projection lens is longer than a thickness of the first polarized beam splitter plus a thickness of the second total internal reflection prism; an interval between the second spatial light modulator and the projection lens is longer than a thickness of the second polarized beam splitter plus the thickness of second total internal reflection prism.

8. The stereoscopic display apparatus of claim 4, wherein an interval between the first spatial light modulator and the projection lens minus 10mm is shorter than a thickness of the second polarized beam splitter plus a thickness of the first total internal reflection prism; an interval between the second spatial light modulator and the projection lens minus 10mm is shorter than the thickness of the second polarized beam splitter plus a thickness of the second total internal reflection prism.

9. The stereoscopic display apparatus of claim 1, further comprising:
an integration rod coupled with the light source so that the non-polarized light transmitted through the integration rod to the first polarized beam splitter.
